(19) United States
(12) Patent Application Publication
(10) Pub. No.: US 2014/0009492 A1
(43) Pub. Date: Jan. 9, 2014

(54) DISPLAY APPARATUS AND METHOD AND NON-TRANSITORY COMPUTER READABLE MEDIUM

(71) Applicant: FUJI XEROX CO., LTD., Tokyo (JP)

(72) Inventor: Toshihide FUJII, Kanagawa (JP)

(73) Assignee: FUJI XEROX CO., LTD., Tokyo (JP)

(21) Appl. No.: 13/752,553

(22) Filed: Jan. 29, 2013

(30) Foreign Application Priority Data
Jul. 4, 2012 (JP) 2012-150400

(51) Int. Cl. G09G 5/32

(52) U.S. Cl. CPC G09G 5/32
USPC 345/629

(57) ABSTRACT

A display apparatus includes a display having a display screen that displays an image; a display control unit that displays a page selected from ordered pages in a first region of the display screen and partial images representing portions of the pages other than the selected page in a second region different from the first region; a first acquiring unit that acquires first information indicating the orientation of the display apparatus; a setting unit that sets the size of the partial images displayed on the display depending on the orientation indicated by the first information; a second acquiring unit that acquires second information indicating a position where a user touches the display screen; and a selecting unit that selects a page associated with a partial image covering the position indicated by the second information if the position lies within the second region.

### CROSS-REFERENCE TO RELATED APPLICATIONS

This application is based on and claims priority under 35 USC 119 from Japanese Patent Application No. 2012-150400 filed Jul. 4, 2012.

### BACKGROUND

### Technical Field

The present invention relates to display apparatuses and methods and non-transitory computer readable media.

### SUMMARY

According to an aspect of the invention, there is provided a display apparatus including a display having a display screen that displays an image; a display control unit that displays a page selected from ordered pages in a first region of the display screen and partial images representing portions of the pages other than the selected page in a second region different from the first region; a first acquiring unit that acquires first information indicating the orientation of the display apparatus; a setting unit that sets the size of the partial images displayed on the display depending on the orientation indicated by the first information; a second acquiring unit that acquires second information indicating a position where a user touches the display screen; and a selecting unit that selects a page associated with a partial image covering the position indicated by the second information if the position lies within the second region.

### BRIEF DESCRIPTION OF THE DRAWINGS

An exemplary embodiment of the present invention will be described in detail based on the following figures, wherein:

FIG. 1 illustrates the external appearance of a display apparatus according to an exemplary embodiment of the present invention;

FIG. 2 is a block diagram illustrating the hardware configuration of the display apparatus;

FIGS. 3A and 3B illustrate an example of a document displayed on a display screen;

FIG. 4 is a block diagram illustrating the functional configuration of a controller of the display apparatus;

FIG. 5 is a flowchart of the operation of the display apparatus;

FIGS. 6A and 6B illustrate how a page is selected based on a touch point;

FIG. 7 illustrates an example of a tilted orientation of the display apparatus;

FIG. 8 illustrates an example of a document displayed on the display screen when the acceleration is higher than or equal to a threshold;

FIGS. 9A and 9B illustrate how the width of partial images is changed;

FIGS. 10A and 10B illustrate a designated-page selection procedure in a modification.

FIGS. 11A and 11B illustrate how the width of the partial images is changed in another modification.

FIG. 12 illustrates an example of the shape of the partial images in another modification;

FIG. 13 illustrates an example of an edge region in another modification; and

FIGS. 14A to 14C illustrate how a selected-page region is resized in another modification.

### DETAILED DESCRIPTION

### 1. Exemplary Embodiment

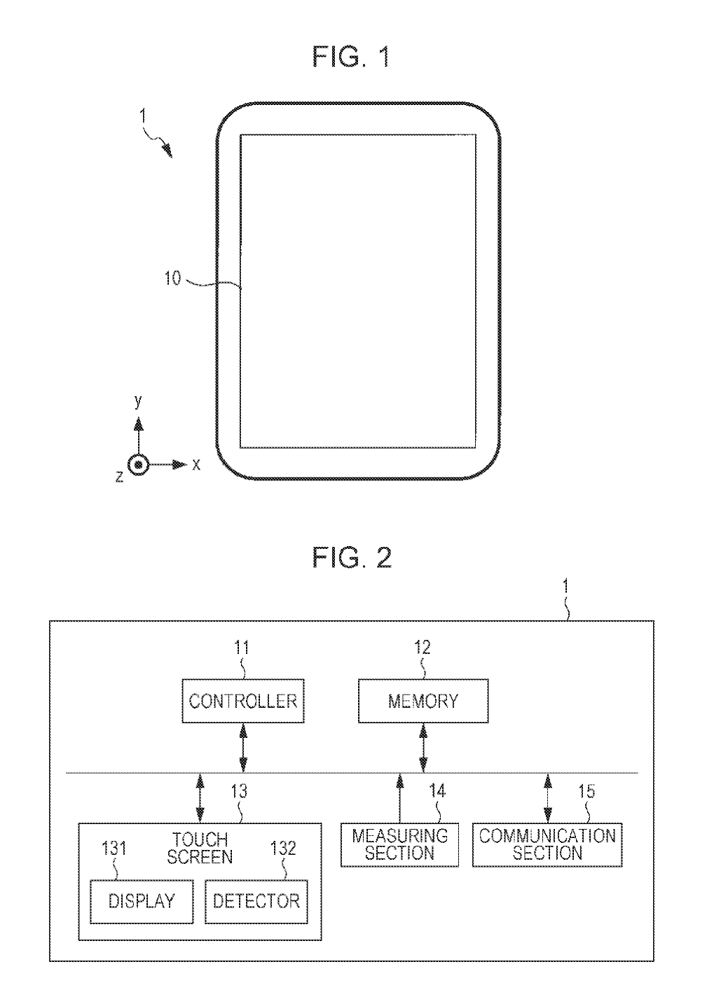

FIG. 1 illustrates the external appearance of a display apparatus 1 according to an exemplary embodiment of the present invention. The display apparatus 1 is an electronic device having a display screen 10. The display screen 10 displays an image and accepts finger touch operations from the user. In the example herein, the display screen 10 is a portrait-oriented rectangular screen. The display screen 10 may allow the user to view an image three-dimensionally using a technique such as naked-eye stereopsis.

To describe and illustrate the arrangement of the elements of the display apparatus 1 in the detailed description and the drawings, the space in which the elements are arranged is defined by an xyz right-handed coordinate space. In the drawings, the encircled dot represents an arrow pointing out of the page toward the viewer, and the encircled cross represents an arrow pointing away from the viewer into the page. The direction along the x-axis in the coordinate space is referred to as “x-axis direction.” The direction in which the x component increases is referred to as “+x direction,” whereas the direction in which the x component decreases is referred to as “−x direction.” Similarly, the y-axis direction, the +y direction, the −y direction, the z-axis direction, the +z direction, and the −z direction are defined. Also defined are the directions in a right-handed coordinate space, described later. The −z direction is the downward direction, i.e., the direction in which gravity acts on an object. Unless otherwise indicated, the display apparatus 1 is oriented such that the display screen 10 faces the +z direction, the lateral direction thereof is parallel to the x-axis, and the longitudinal direction thereof is parallel to the y-axis. This orientation is hereinafter referred to as “basic orientation.”

The display apparatus 1 is sized to allow the user to operate the display screen 10 with a finger. The display apparatus 1 is, for example, a cellular phone (including smart phones), a tablet or slate personal computer (PC), or a personal digital assistant (PDA). The display apparatus 1 may be sized to be held in the hand or may be designed to be placed on a table or attached to a holder during use. The display apparatus 1 need not necessarily be flat.

FIG. 2 is a block diagram illustrating the hardware configuration of the display apparatus 1. The display apparatus 1 includes a controller 11, a memory 12, a touch screen 13, a measuring section 14, and a communication section 15. In addition to the components shown in FIG. 2, the display apparatus 1 may include other devices such as a speaker and a microphone (or input/output interfaces thereof), a camera (including video cameras), and a vibrator.

The controller 11 controls the operation of various sections of the display apparatus 1. The controller 11 includes a processor such as a central processing unit (CPU) and memories such as a read-only memory (ROM) and a random-access memory (RAM). The controller 11 executes programs stored in the ROM or the memory 12 to implement a graphical user interface (GUI) according to this exemplary embodiment.

The memory 12 stores data. The memory 12 includes a storage medium, such as a hard disk or flash memory, for storing data to be used by the controller 11. The memory 12 may include a removable disk, i.e., a removable storage medium. The memory 12 stores programs to be executed by the controller 11 and document data representing documents to be displayed on the display screen 10. As used herein, the term “document” refers to a set of ordered pages that represent information as characters, images, or combinations thereof arranged in the regions of the pages. A document is displayed as an image on the display apparatus 1. The term “document data” refers to data that represents a document and that is stored and read by machine. The memory 12 may also store identification information for identifying users if the same user uses different display apparatuses 1 or if different users use the same display apparatus 1.

The touch screen 13 displays an image and accepts user operations. Specifically, the touch screen 13 includes a display 131 that displays an image on the display screen 10 and a detector 132 that detects a position where the user touches the display screen 10, for example, with a finger, to accept user operations.

The display 131 includes a display panel that displays an image, such as a liquid crystal display panel or organic electroluminescent (EL) display panel, and a drive circuit that drives the display panel. The display 131 displays an image based on data supplied from the controller 11 on the display screen 10. The detector 132 includes a sensor that detects a finger touch to the display screen 10. When the detector 132 detects a finger touch at a certain position (hereinafter referred to as “touch point”), it supplies touch point information indicating the touch point to the controller 11. The detector 132 may be configured to simultaneously detect multiple touch points, i.e., multi-touch compatible.

The measuring section 14 measures the orientation of the display apparatus 1. For example, the measuring section 14 includes a three-axis acceleration sensor and measures the acceleration of the display apparatus 1 along the coordinate axes of the coordinate space applied to display apparatus 1. Based on the measured acceleration, the measuring section 14 determines the angle of the display apparatus 1 to the gravitational direction and outputs orientation information indicating the orientation of the display apparatus 1.

The communication section 15 communicates data. The communication section 15 may be an interface connected to a communication network such as a mobile communication network or the Internet. Alternatively, the communication section 15 may be wirelessly connected to another electronic device, as in near field communication (NFC).

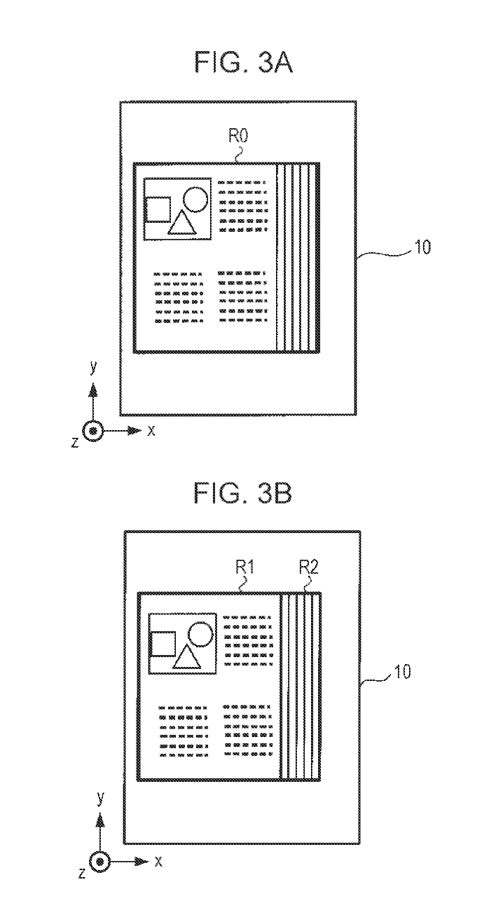

The controller 11 of the display apparatus 1 executes the programs described above to display a document on the display screen 10 based on document data read from the memory 12. FIGS. 3A and 3B illustrate an example of a document displayed on the display screen 10. As shown in FIG. 3A, the document is displayed in a certain region of the display screen 10. This region is referred to as “document region R0.”

The document region R0 may occupy the entire display screen 10. As shown in FIG. 3B, the document region R0 includes a selected-page region R1 that displays the content of a page selected from the document (hereinafter referred to as “selected page”) and an edge region R2 representing portions of the pages other than the selected page along an edge of the document. The term “edge” generally refers to the name of a portion of a book. In bookbinding, this term refers to cut edges on the three sides of a book other than the spine thereof. As used herein, the term “edge” is applied to digitized documents to mean a portion of a digitized document where sides of pages are gathered. As used herein, the term “document” encompasses both books, which have a spine, and stacks of pages without a spine.

In the example shown in FIG. 3B, the rectangular regions including the right sides of the pages represent the portions of the respective pages along the edge. The images representing the portions of the respective pages along the edge are referred to as “partial images.”

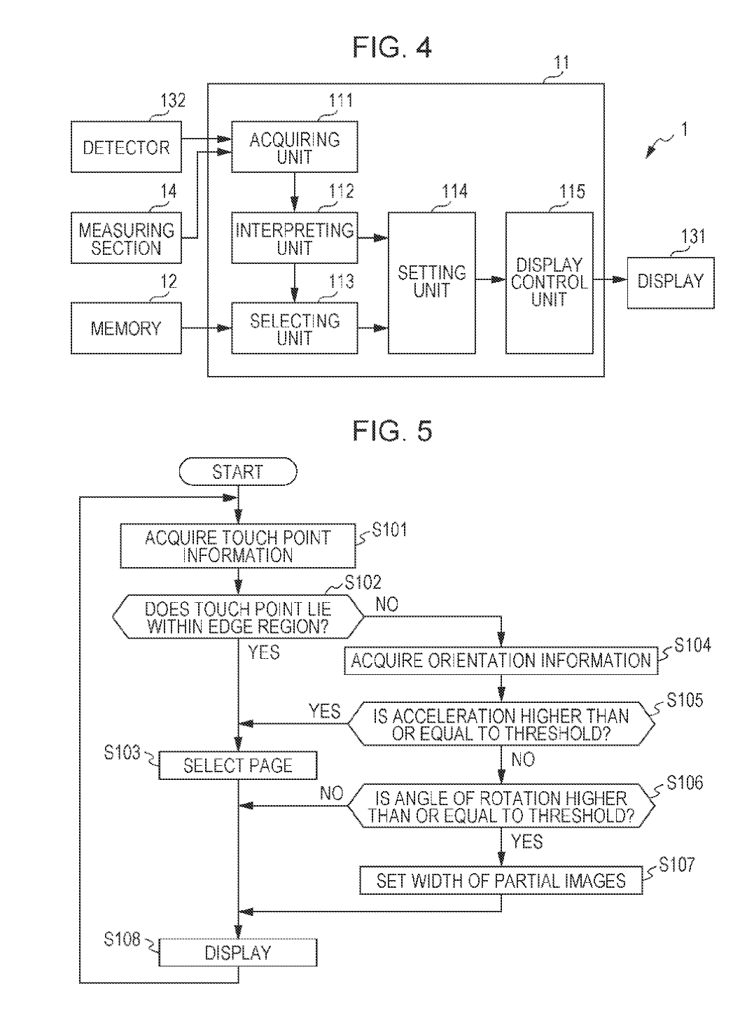

FIG. 4 is a block diagram illustrating the functional configuration of the controller 11 of the display apparatus 1. The controller 11 executes the programs described above to function as an acquiring unit 111, an interpreting unit 112, a selecting unit 113, a setting unit 114, and a display control unit 115. The acquiring unit 111 acquires touch point information indicating a touch point detected by the detector 132 of the touch screen 13. The acquiring unit 111 also acquires orientation information indicating the orientation measured by the measuring section 14.

Based on the information acquired by the acquiring unit 111, the interpreting unit 112 interprets the user operation. Based on the results of interpretation by the interpreting unit 112, the selecting unit 113 selects a page from the document and reads the content of the selected page from the memory 12. Based on the results of interpretation and the content of the selected page, the setting unit 114 sets the layout of the image to be displayed on the display screen 10. Based on the layout set by the setting unit 114, the display control unit 115 controls the display 131 to display the selected page in the selected-page region R1 and the portions of the pages other than the selected page along the edge in the edge region R2.

FIG. 5 is a flowchart of the operation of the display apparatus 1. The controller 11 of the display apparatus 1 acquires touch point information from the detector 132 (step S101) and determines whether the touch point indicated by the touch point information lies within the edge region R2 (step S102). If the controller 11 determines that the touch point lies within the edge region R2 (YES in step S102), it selects a page depending on the user operation (step S103). Specifically, the controller 11 selects a page associated with a partial image covering the touch point from the pages of the document. The controller 11 then controls the display 131 of the touch screen 13 to display the document on the display screen 10 (step S108).

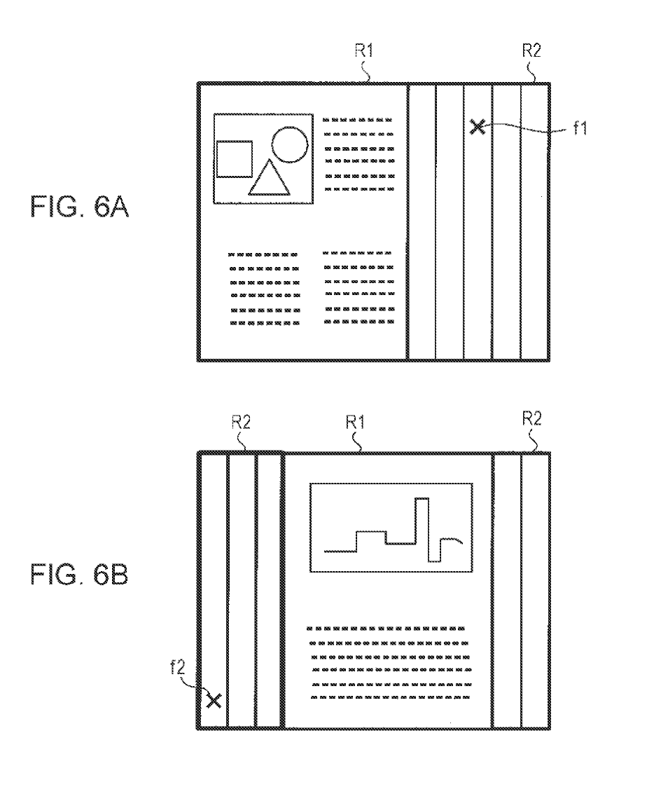

FIGS. 6A and 6B illustrate how a page is selected based on a touch point. The document shown in FIGS. 6A and 6B includes six pages. In FIGS. 6A and 6B, the first page of the document is selected. Accordingly, the selected-page region R1 displays the first page of the document, and the edge region R2 displays the partial images of the second to sixth pages.

When the user's finger touches a touch point f1 indicated by the cross in FIG. 6A, the controller 11 determines that the touch point f1 lies within the edge region R2 and selects a page associated with a partial image covering the touch point f1. Because the touch point f1 lies within the partial image representing the portion of the fourth page along the edge, the controller 11 selects the fourth page. The display screen 10 then displays the document as shown in FIG. 6B. Specifically, the selected-page region R1 displays the content of the fourth page of the document. At the same time, the edge region R2 is divided into two regions on both sides of the selected-page region R1. The left edge region R2 displays the partial images of the first to third pages. The right edge region R2 displays the partial images of the five and sixth pages.

The partial images displayed in the left edge region R2 represent rectangular regions including the left sides of the pages. When the user's finger touches a touch point f2 indicated by the cross in FIG. 6B, the controller 11 selects the first page because the touch point f2 lies within the partial image representing the portion of the first page along the edge, and the display screen 10 displays the image shown in FIG. 6A.

Otherwise, if the controller 11 determines that the touch point does not lie within the edge region R2 (NO in step S102), it acquires orientation information from the measuring section 14 (step S104) and determines whether the acceleration indicated by the orientation information is higher than or equal to a threshold (e.g., 9.8 m/s²) (step S105). The acceleration may be the acceleration measured by the acceleration sensor along the coordinate axes or may be the rotational acceleration about a predetermined axis, for example, an axis of rotation parallel to the y-axis. That is, the acceleration may be any type of acceleration determined based on the orientation information.

If the controller 11 determines that the acceleration is higher than or equal to the threshold (YES in step S105), the flow proceeds to step S103, where the controller 11 selects a page depending on the user operation.

Specifically, the controller 11 selects a predetermined page from the pages of the document depending on the acceleration indicated by the orientation information.

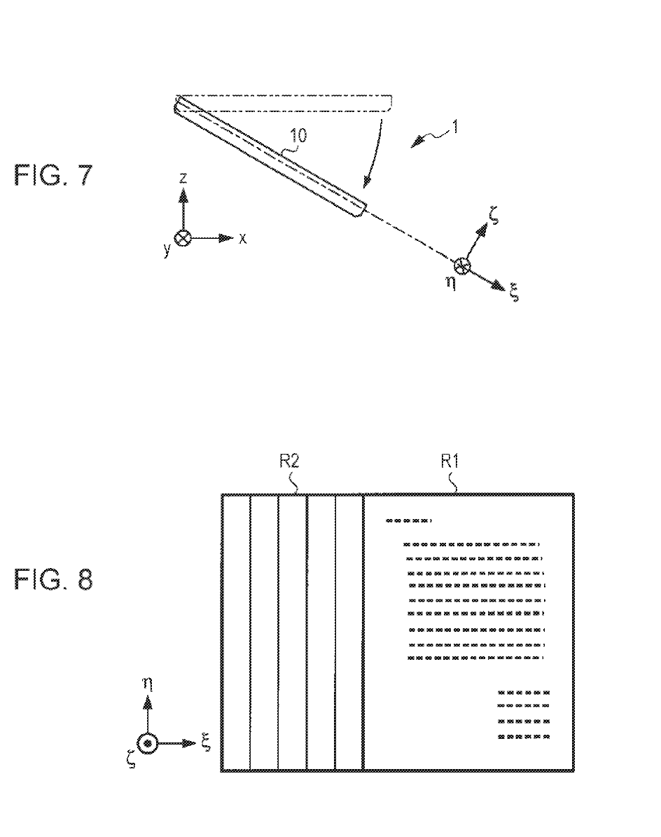

FIG. 7 illustrates an example of a tilted orientation of the display apparatus 1. For example, as shown in FIG. 7, the user tilts the display apparatus 1 by rotating it about an axis of rotation parallel to the y-axis direction in the direction indicated by the arrow. In the resulting orientation of the display apparatus 1, the side facing the +x direction is lower (in the −z direction) than the side facing the −x direction. This orientation will be described using a ξηξ right-handed coordinate space, where the ξ-axis direction is defined as the lateral direction of the display screen 10 of the display apparatus 1, the η-axis direction is defined as the longitudinal direction thereof, and the +ζ direction is defined as the direction in which the display screen 10 faces. Because the ξηξ right-handed coordinate space is a relative coordinate space based on the plane of the display screen 10, an image displayed on the display screen 10 is represented in the ξη plane, which includes the ξ-axis and the η-axis, irrespective of the orientation of the display apparatus 1. When the display apparatus 1 is in the basic orientation, the ξ-axis coincides with the x-axis, the η-axis coincides with the y-axis, and the ζ-axis coincides with the z-axis.

FIG. 8 illustrates an example of a document displayed on the display screen 10 when the acceleration is higher than or equal to the threshold. The display apparatus 1 is configured to select the last page of the document when tilted at an acceleration higher than or equal to the threshold in the direction indicated by the arrow in FIG. 7. Thus, the controller 11 selects the last page, i.e., the sixth page, and the display 131 displays the document on the display screen 10. Specifically, the selected-page region R1 displays the content of the sixth page of the document, and the edge region R2 is all set to the left of the selected-page region R1 and displays the partial images of the first to fifth pages. The display apparatus 1 may also be configured to select the first page of the document when tilted at an acceleration higher than or equal to the threshold in the direction opposite to the direction indicated by the arrow in FIG. 7.

Otherwise, if the controller 11 determines that the acceleration is lower than the threshold (NO in step S105), it determines the angle of rotation of the display screen 10 from the basic orientation about the y-axis in the clockwise direction based on the orientation information and determines whether the angle of rotation is higher than or equal to a threshold (e.g., 15°) (step S106). If the controller 11 determines that the angle of rotation is lower than the threshold (NO in step S106), the flow proceeds to step S108.

If the controller 11 determines that the angle of rotation is higher than or equal to the threshold (YES in step S106), it sets the value specifying the width of the partial images (step S107) depending on the angle of rotation. The flow then proceeds to step S108.

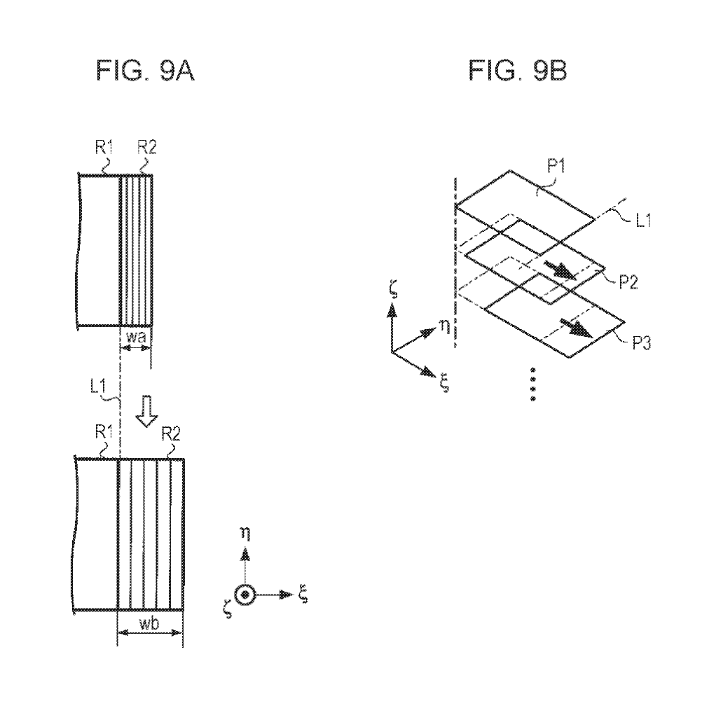

FIGS. 9A and 9B illustrate how the width of the partial images is changed. If the acceleration indicated by the orientation information acquired from the measuring section 14 is lower than the threshold, and the angle of rotation indicated by the orientation information is higher than or equal to the threshold, then the edge region R2 displayed on the display screen 10 changes from the shape shown in the upper half of FIG. 9A into the shape shown in the lower half of FIG. 9A. In this step, the controller 11 sets the value specifying the width of the partial images to change the width of the edge region R2 from wa to wb, which is larger than wa (wa<wb). As a result, the edge region R2 becomes wider. It should be noted that the boundary L1 between the selected-page region R1 and the edge region R2 is fixed.

This may provide the following visual effect to the user. Specifically, as shown in FIG. 9B, the display apparatus 1 displays the document as if pages stacked on top of each other in the +ζ direction were viewed in the −ζ direction in the virtual ξηξ right-handed coordinate space. Each page is parallel to the ξη plane.

When the side of the display screen 10 facing the +ξ direction is tilted downward about an axis of rotation parallel to the η axis, the edge region R2 becomes wider, as described above. Specifically, when the display screen 10 is titled, the edge region R2 is resized such that the lower side thereof is moved away from the opposite side. During resizing, the user may view the document as if the topmost page, i.e., the first page P1, were not moved in the ξ-axis direction and lower pages (in the −ζ direction) among the second and subsequent pages P2, P3, . . . were moved farther in the +ξ direction. This may allow the user to view the document as if the second and subsequent pages were slid along the display screen 10 under the action of gravity.

As described above, the display apparatus 1 displays partial images with the width depending on the angle through which it is tilted. For example, if the user has difficulty in selecting a certain page because the partial image thereof is narrow, the user may tilt the display apparatus 1 so as to enlarge the partial image. This function may provide improved usability, particularly where the user has difficulty in selecting a page by touching a touch screen, rather than using an input device such as a mouth or a keyboard, because of the size of the user's finger.

In addition, the display apparatus 1 displays the first or last page of a document when tilted at an acceleration higher than or equal to the threshold. To view these pages, therefore, the user may tilt the display apparatus 1 quickly without touching the display screen 10.

### 2. Modifications

The following modifications and combinations thereof may be made to the exemplary embodiment described above.

### 2-1. First Modification

Although the controller 11 determines the angle of rotation of the display screen 10 about the y-axis in the clockwise direction based on the orientation information and sets the value specifying the width of the partial images depending on the angle of rotation in the exemplary embodiment described above, it may set the above value depending on the angle of rotation of the display screen 10 about the x-axis in the clockwise direction, or may set the above value depending on both angles of rotation. Alternatively, the controller 11 may set the above value depending on the angle of rotation of the display screen 10 about any axis in the counterclockwise direction.

### 2-2. Second Modification

Although the display apparatus 1 displays the first or last page of a document when tilted at an acceleration higher than or equal to the threshold in the exemplary embodiment described above, it may display other pages. For example, the controller 11 may store any page designated by a user operation in the RAM or the memory 12, and the display apparatus 1 may display the designated page when tilted at an acceleration higher than or equal to the threshold. In this case, the designated page may be labeled with a virtual bookmark or tag for ease of distinguishing from other pages.

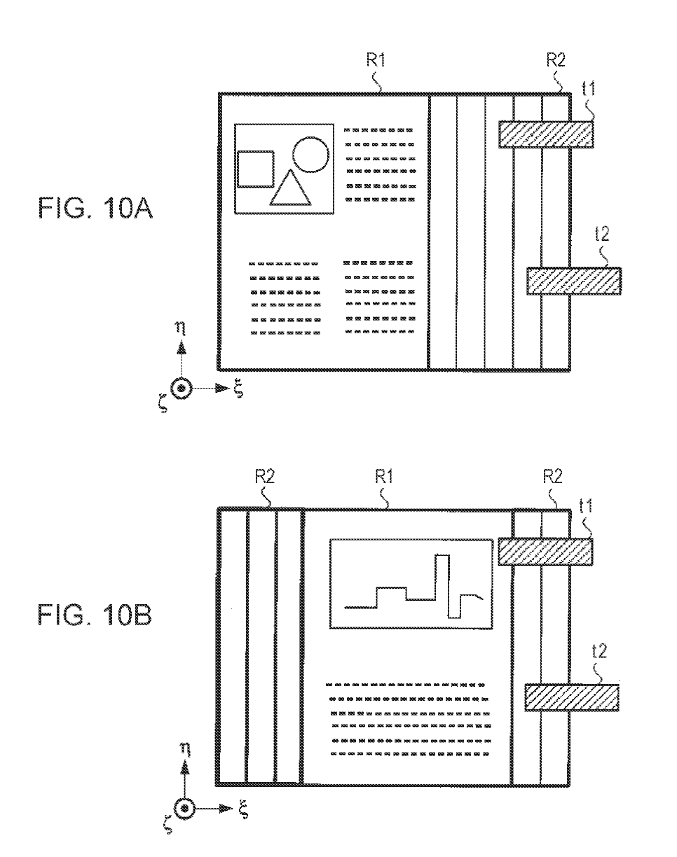

FIGS. 10A and 10B illustrate a designated-page selection procedure in this modification. In FIG. 10A, the first page of the document is selected, and the fourth and fifth pages are labeled with tags t1 and t2, respectively. When the user rotates the display apparatus 1 at an acceleration higher than or equal to the threshold in the direction indicated by the arrow shown in FIG. 7, the controller 11 newly selects the frontmost tagged page from the pages following the selected page. The display screen 10 then displays the document as shown in FIG. 10B.

The controller 11 may also select the rearmost tagged page from the pages following the selected page when the user rotates the display apparatus 1 at an acceleration higher than or equal to the threshold in the direction opposite to the direction indicated by the arrow shown in FIG. 7.

Alternatively, the controller 11 may compare the acceleration to two thresholds. In this case, the controller 11 may select a tagged page if the acceleration exceeds the lower threshold, and may select the first or last page if the acceleration exceeds the higher threshold.

### 2-3. Third Modification

Although the edge region R2 is resized such that the lower side thereof is moved away from the opposite side when the display screen 10 is tilted in the exemplary embodiment described above, the edge region R2 may be resized in other manners. For example, the edge region R2 may be resized such that the lower side thereof is approached by the opposite side.

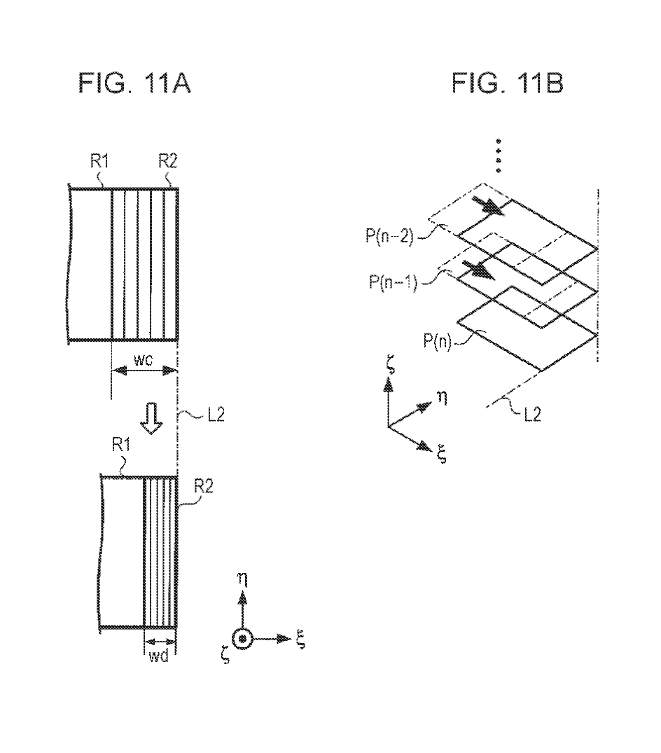

FIGS. 11A and 11B illustrate how the width of the partial images is changed in this modification. If the acceleration indicated by the orientation information acquired from the measuring section 14 is lower than the threshold, and the angle of rotation indicated by the orientation information is higher than or equal to the threshold, then the edge region R2 displayed on the display screen 10 changes from the shape shown in the upper half of FIG. 11A into the shape shown in the lower half of FIG. 11A. In this step, the controller 11 sets the value specifying the width of the partial images to change the width of the edge region R2 from wc to wd, which is smaller than wc (wc>wd). As a result, the edge region R2 becomes narrower. It should be noted that the boundary L2 along the right side of the edge region R2 is fixed; instead, the boundary between the selected-page region R1 and the edge region R2 is moved in the +ξ direction.

This may provide the following visual effect to the user. Specifically, as shown in FIG. 11B, the display apparatus 1 displays the document as if pages stacked on top of each other in the +ζ direction were viewed in the −ζ direction in the virtual ξηξ right-handed coordinate space. Each page is parallel to the ξη plane. The document includes n pages.

When the side of the display screen 10 facing the +ξ direction is tilted downward about an axis of rotation parallel to the η axis, the edge region R2 becomes narrower, as described above. Specifically, when the display screen 10 is titled, the edge region R2 is resized such that the lower side thereof is approached by the opposite side. During resizing, the user may view the document as if the bottommost page, i.e., the n-th page P(n), were not moved in the ξ-axis direction and upper pages (in the +ξ direction) among the (n−1)th and preceding pages P(n−1), P(n−2), . . . were moved farther in the +ξ direction. This may allow the user to view the document as if the (n−1)th and preceding pages slid along the display screen 10 under the action of gravity.

### 2-4. Fourth Modification

Although the partial images are represented by rectangular regions including the left or right sides of the pages in the exemplary embodiment described above, they may be represented by rectangular regions including the top or bottom sides of the pages. Alternatively, the partial images may be represented by L-shaped regions formed by rectangular regions including the left or right sides of the pages and rectangular regions including the top or bottom sides of the pages.

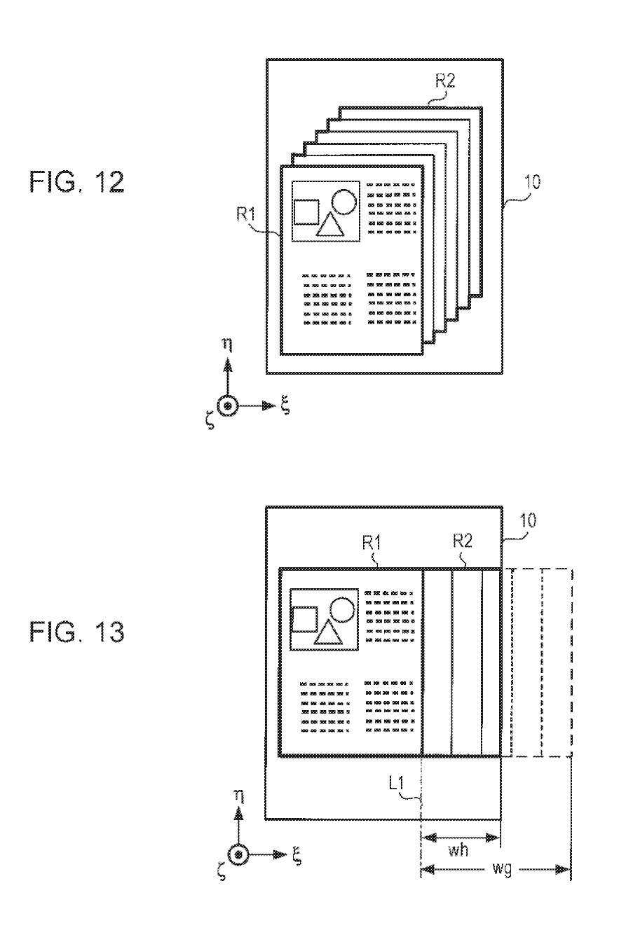

FIG. 12 illustrates an example of the shape of the partial images in this modification. In the example shown in FIG. 12, the L-shaped regions formed by the rectangular regions including the right sides of the pages and the rectangular regions including the top sides of the pages represent portions of the pages along edges. In this case, as in the first modification, the controller 11 may determine the angle of rotation about the y-axis and the angle of rotation about the x-axis and set the values specifying the width and height of the partial images depending on both angles of rotation. That is, the setting unit 114, implemented by the controller 11, may set the size of the partial images displayed on the display screen 10 depending on the orientation indicated by the information acquired by the acquiring unit 111.

Specifically, the controller 11 determines the angle of rotation about the x-axis in the clockwise or counterclockwise direction and sets the value specifying the height of the rectangular regions of the partial images including the top sides of the pages depending on the angle of rotation. The controller 11 then determines the angle of rotation about the y-axis in the clockwise or counterclockwise direction and sets the value specifying the width of the rectangular regions of the partial images including the right sides of the pages depending on the angle of rotation.

### 2-5. Fifth Modification

Although the edge region R2 represents the portions of all pages except the selected page along the edge of the document in the exemplary embodiment described above, the edge region R2 may represent the portions of some of the pages except the selected page along the edge of the document.

FIG. 13 illustrates an example of the edge region R2 in this modification. The edge region R2 shown in FIG. 13 is set to the right of the selected-page region R1. The total width of the partial images is wg, and the distance from the boundary L1 between the selected-page region R1 and the edge region R2 to the right side of the display screen 10 in the ξ-axis direction is wh.

As shown in FIG. 13, when the display apparatus 1 is tilted to extend the edge region R2 in the +ξ direction, wg may become larger than wh (wg>wh). In this state, the region covering all partial images extends off the display screen 10 in the +ξ direction. As shown in FIG. 13, the controller 11 of the display apparatus 1 displays the edge region R2 within the display screen 10. Thus, the edge region R2 has a width of wh and represents the portions of some of the pages except the selected page along the edge of the document. In the example shown in FIG. 13, the edge region R2 displays the partial images of the second to fourth pages.

### 2-6. Sixth Modification

Although the controller 11 sets the size of the partial images displayed on the display 131 depending on the orientation of the display apparatus 1 in the exemplary embodiment and modifications described above, it may also set the size of the selected-page region R1.

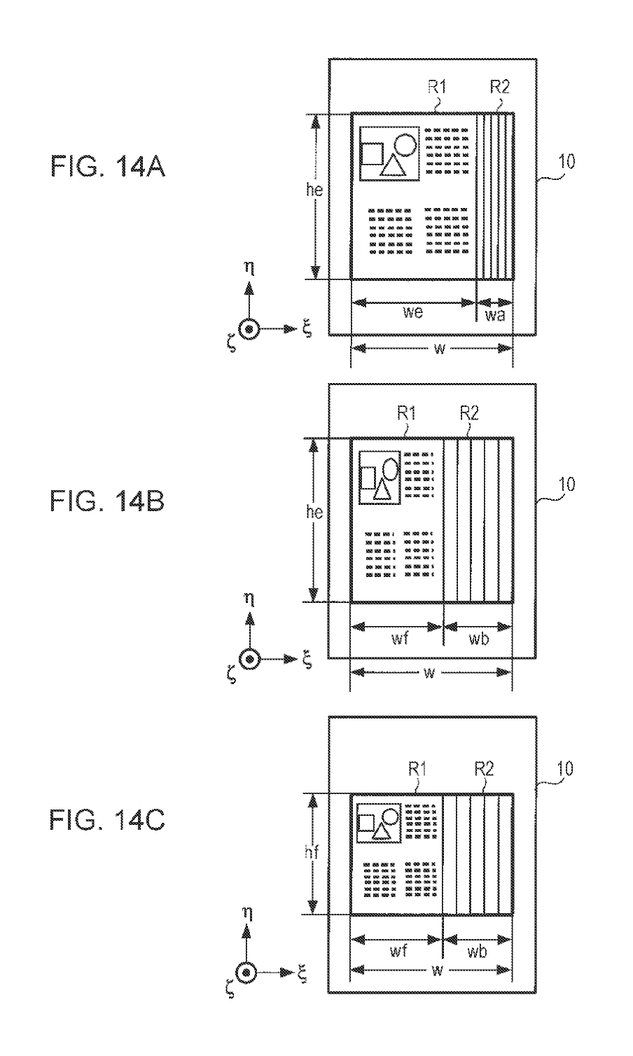

FIGS. 14A to 14C illustrate how the selected-page region R1 is resized in this modification. As shown in FIG. 14A, the display screen 10 displays the content of the first page in a selected-page region R1 having a height of he and a width of we and also displays an edge region R2 having a height of he and a width of wa to the right of the selected-page region R1. The sum of we and wa is w (we+wa=w).

When the user tilts the display apparatus 1, the controller 11 sets the width (size) of the partial images depending on the orientation of the display apparatus 1. As a result, as shown in FIG. 14B, the width of the edge region R2 is changed to wb, which is larger than wa (wa<wb). At the same time, the controller 11 sets the width of the selected-page region R1 such that the sum of the widths of the selected-page region R1 and the edge region R2 remains w. Specifically, the controller 11 sets the width of the selected-page region R1 to wf, which is smaller than we (we>wf). As a result, the sum of the widths of the selected-page region R1 and the edge region R2 remains w (wf+wb=w).

Alternatively, the controller 11 may set the size of the selected-page region R1 such that the aspect ratio thereof remains constant. When the controller 11 changes the width of the edge region R2 to wb, which is larger than wa, and the width of the selected-page region R1 to wf, which is smaller than we, as described above, the controller 11 changes the height of the selected-page region R1 from he to hf so that the aspect ratio thereof remains constant. After resizing, the aspect ratio of the selected-page region R1 remains constant (he:we=hf:wf).

### 2-7. Seventh Modification

Although the measuring section 14 of the display apparatus 1 includes a three-axis acceleration sensor and measures the acceleration of the display apparatus 1 along the coordinate axes of the coordinate space applied to the display apparatus 1 to determine the angle of the display apparatus 1 to the gravitational direction and to output orientation information indicating the orientation of the display apparatus 1 in the exemplary embodiment described above, the display apparatus 1 may include other sensors. In addition, although the display apparatus 1 acquires the orientation information indicating the orientation thereof from the measuring section 14, it may acquire the orientation information in other manners. For example, an imaging device such as a camera for monitoring the display apparatus 1 may be disposed in the space where the display apparatus 1 is disposed, and the controller 11 may acquire an image captured by the imaging device, for example, via the communication section 15, as the orientation information indicating the orientation of the display apparatus 1. The controller 11 does not necessarily acquire the captured image itself; it may acquire position information generated by an external device based on the image. The orientation of the display apparatus 1 may be detected by other external devices such as ultrasonic and infrared devices. That is, the controller 11 may acquire any type of orientation information that indicates the orientation thereof, for example, the tilt of the display screen 10 with respect to the gravitational direction.

Although the display apparatus 1 may allow the user to view the document as if the pages displayed on the display screen 10 slid along the display screen 10 under the action of gravity in the exemplary embodiment described above, it may allow the user to view the document in other manners. For example, the display apparatus 1 may determine the position of the user's eyes and, when the display screen 10 is tilted such that the pages of the document are moved away from that position, may allow the user to view the document as if the pages were moved away from the position of the user's eyes by the corresponding distance. In this case, the display apparatus 1 may have an imaging device such as a camera near the display screen 10 and may detect the user's face viewing the display screen 10 to determine the position of the user's eyes. That is, the display apparatus 1 may be configured to move the pages of a document depending on the relative positional relationship with the user. This may allow the user to operate the display apparatus 1 depending on the user's orientation, for example, even in a space where the user senses no gravity, as in a gravity-free space.

### 2-8. Eighth Modification

Although the controller 11 selects a predetermined page from the pages of the document depending on the acceleration indicated by the orientation information if the controller 11 determines that the acceleration is higher than or equal to the threshold in the exemplary embodiment described above, the controller 11 need not select a page depending on the acceleration. In this case, the controller 11 need not compare the acceleration indicated by the orientation information to the threshold or determine the acceleration from the orientation information.

### 2-9. Ninth Modification

The programs executed by the controller 11 of the display apparatus 1 may also be provided as a computer-readable storage medium storing the programs. Examples of computer-readable storage media include magnetic storage media such as magnetic tapes and magnetic disks, optical storage media such as optical disks, magneto-optical storage media, and semiconductor memories. The programs may also be downloaded via a communication network such as the Internet. The CPU used for the controller 11 may be replaced by various other devices such as dedicated processors.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display apparatus comprising:
a display having a display screen that displays an image;
a display control unit that displays a page selected from a plurality of ordered pages in a first region of the display screen and partial images representing portions of the pages other than the selected page in a second region different from the first region;
a first acquiring unit that acquires first information indicating the orientation of the display apparatus;
a setting unit that sets the size of the partial images displayed on the display depending on the orientation indicated by the first information;
a second acquiring unit that acquires second information indicating a position where a user touches the display screen; and
a selecting unit that selects a page associated with a partial image covering the position indicated by the second information if the position lies within the second region.

2. The display apparatus according to claim 1, wherein the selecting unit determines the acceleration of the display apparatus based on the orientation indicated by the first information and, if the acceleration is higher than or equal to a threshold, selects a predetermined page depending on the acceleration.

3. A display method comprising:
displaying a page selected from a plurality of ordered pages in a first region of a display screen of a display of a display apparatus and partial images representing portions of the pages other than the selected page in a second region different from the first region;
acquiring first information indicating the orientation of the display apparatus;
setting the size of the partial images displayed on the display depending on the orientation indicated by the first information;
acquiring second information indicating a position where a user touches the display screen; and
selecting a page associated with a partial image covering the position indicated by the second information if the position lies within the second region.

4. A non-transitory computer readable medium storing a program causing a computer to execute a display process comprising:
displaying a page selected from a plurality of ordered pages in a first region of a display screen of a display of a display apparatus and partial images representing portions of the pages other than the selected page in a second region different from the first region;
acquiring first information indicating the orientation of the display apparatus;
setting the size of the partial images displayed on the display depending on the orientation indicated by the first information;
acquiring second information indicating a position where a user touches the display screen; and
selecting a page associated with a partial image covering the position indicated by the second information if the position lies within the second region.
